(19) United States
(12) Patent Application Publication
(10) Pub. No.: US 2023/0289228 A1
(43) Pub. Date: Sep. 14, 2023

(54) INFRASTRUCTURE COMPOSITION FUNCTION DEPLOYMENT ON A CONTAINER ORCHESTRATION PLATFORM

(71) Applicant: Hewlett Packard Enterprise Development LP, Spring, TX (US)

(72) Inventors: Govardhan CHINTHA, Bangalore (IN); Vinayak RAM, Bangalore (IN); Vijaianand SUNDARAMOORTHY, Bangalore (IN)

(21) Appl. No.: 17/820,893

(22) Filed: Aug. 19, 2022

(30) Foreign Application Priority Data
Mar. 8, 2022 (IN) 202241012673

(51) Int. Cl. G06F 9/50

(52) U.S. Cl. CPC G06F 9/5027

(57) ABSTRACT

Examples described herein relate to composition of resources. According to some examples, the process of composition of resources may include identifying a composer system-object and reading a set of infrastructure requirements from the composer system-object by a controller. The set of infrastructure requirements may include an infrastructure manager-type and a resource specification. In response to a query for resources based on the resource specification, receiving, by a controller, a list of resources from the infrastructure manager. Identifying, by the controller, a set of resources from the list of resources that are suitable for the set of infrastructure requirements. Updating, by the controller, the composer system-object with a resource information based on the set of resources that are identified and a status field indicating a completion of the composition of resources.

### BACKGROUND

Edge computing is, in some respects, a paradigm shift in computational dynamics. Generally, “edge computing” may refer to deployment of computing resources in proximity to data collected at a source, as compared to traditional data centers that may have computing resources deployed local to the data center but remotely from the data source. Further, edge computing may offer an improved computing experience due to reduced latency and improved throughput due to their proximity to a data source. Further, a data center, which offers services such as processing, storage, and/or exchange of data may be deployed at various geographical locations including the Edge. A data center may include multiple resources, e.g., servers, that can be virtualized to form a resource pool by using server virtualization techniques. Hardware and/or virtual resources during their lifecycle may be managed by infrastructure managers. Various infrastructure managers with different interfaces may be used for the management of infrastructure resources.

### BRIEF DESCRIPTION OF THE DRAWINGS

The present disclosure, in accordance with one or more various examples, is described in detail with reference to the following figures. The figures are provided for purposes of illustration only and merely depict examples, wherein:

FIG. 1A depicts a schematic view of a physical topology of a network environment that may be implemented for a telecom service provider, according to various examples of the present disclosure;

FIG. 1B illustrates an example of a method for composition of infrastructure resources, according to the present disclosure;

FIG. 2 illustrates an example of a schematic view of a computing platform in a network architecture, according to the present disclosure;

FIG. 3 illustrates an example of another schematic view of a network architecture and interactions among various components therein, in accordance with the present disclosure;

FIG. 4A illustrates a schematic view of an infrastructure manager-object, according to various examples of the present disclosure;

FIG. 4B illustrates a schematic view of a secret object, according to various examples of the present disclosure;

FIG. 4C illustrates a schematic view of a composer system-object, according to various examples of the present disclosure;

FIG. 5A illustrates a sequence diagram for creation of various objects, which can be utilized for composition of resources, per various examples of the present disclosure;

FIG. 5B illustrates a sequence diagram for a process for composition of resources, per various examples of the present disclosure; and

FIG. 6 illustrates an example computer system that may be used in implementing various examples discussed herein.

The figures are not exhaustive and do not limit the present disclosure to the precise form disclosed.

### DETAILED DESCRIPTION

With the proliferation of data-intensive technologies, such as data-heavy, immersive mobile applications, connected technologies (e.g., Internet of Things (IoT)), and mission-critical use cases (e.g., self-driving cars), there can be a demand for low latency and high throughput data services. In order to cater to such demands, Telecom Service Providers (TSPs) are developing high-speed telecommunications, or telecom, technologies, such as 5G communication systems. The integration of edge computing, or computing at “the Edge” may enable the evolution of such telecom technologies by bringing computing resources closer to a user. Thus, TSPs may have data centers that are distributed and deployed closer to cellular base stations for edge computing. In some instances, TSPs may build an ecosystem that may enable enterprises to run applications at the Edge for offering improved Quality of Service to users.

Generally, data centers may include servers for network, storage, and/or computing applications. As discussed earlier, these data centers can be increasingly distributed and deployed at the Edge. At the Edge, operational and/or environmental conditions may be different from that of traditional data centers. Moreover, environmental and other external conditions from one location may vary from that of another. For example, operating temperature range, space availability, etc., may vary drastically. Hence, TSPs may use heterogeneous systems that may be customized to cope with operational and/or environmental conditions at the Edge. Examples of heterogeneous systems can be servers with flexible form factors, smart Network Interface Cards (NICs), workload accelerators, devices with different operating temperatures, etc. Multiple vendors may be involved to address such diverse infrastructure resource requirements and/or to reduce dependency on a few vendors. Therefore, in some instances, a network architecture may have a heterogeneous mix of infrastructure resources, which may be geographically distributed. TSPs should be capable of managing such network architectures and their infrastructure resources seamlessly, in order to provide an enhanced experience to enterprises and users.

A network architecture may include a composable infrastructure that may treat compute, storage, and/or network devices as pool(s) of resources that can be provisioned depending on workload/network service requirements. In some instances, a user may request infrastructure resources for executing workload(s). Infrastructure resources can be composed for workload requirements by using a combination of network, storage, and/or compute resources. Upon completion of workloads, composed resources can be released to the pool. For workloads that may use Virtual Network Functions (VNFs), a resource orchestrator may define a topology and virtual/physical resource requirements. A resource orchestrator may send requests to a resource composer for the composition of infrastructure resources.

The network architecture may include an infrastructure manager, which can manage virtualized infrastructure. “Virtual infrastructure” may use physical infrastructure, but instead of an operating system, a hypervisor may be installed. A hypervisor can be a specialized software that runs Virtual Machines (VMs) by utilizing underlying hardware. Further, a resource composer, via an infrastructure manager and resource Application Programming Interfaces (APIs) exposed to it, may identify resources and return composed resources to the resource orchestrator. The resource orchestrator can then configure the identified resources to run workload(s) associated with network services. In some instances, apart from northbound applications (e.g., a resource orchestrator), a user, such as a telecon user, a network administrator, or the like, may want to deploy a Virtual Network Function (VNF) for a network service at a specific region in a network architecture. As the network resources sprawl across geographies, a vendor for infrastructure resources and corresponding infrastructure manager may vary from one region to another. Thus, the user may have to be familiar with composition service standards corresponding to the region in which the VNF may be deployed. Vendors may use proprietary standards or any of the open-source standards. Infrastructure deployed at the Edge may interface with a central resource composer. Such resource composers may receive multiple resource requests. This creates challenges for network scalability. Moreover, as network resources sprawl across geographies with a huge number of components deployed near the Edge, it may not be possible to collocate both the resource composer and the resource orchestrator in a central/regional datacenter. In some other instances, certain resource composers may be deployed near the Edge to address some of the aforementioned shortcomings. However, it may be challenging to deploy physical resource composers near the Edge due to physical space limitations or other conditions. Thus, a composers' infrastructure may have to be customized to suit environmental/operating conditions at the Edge.

The present disclosure addresses one or more of the aforementioned shortcomings by providing an Infrastructure Composition Function (ICF) for composition of resources in a network architecture. Instead of depending on dedicated hardware resources at a central or a distributed data center, examples disclosed herein provide an ICF that can be deployed on a container orchestration platform (e.g., Kubernetes). For example, a container orchestration platform may be ubiquitous in evolving network architectures, such as a 5G, for running network functions, enterprise applications, or TSP-related applications. According to some examples, an ICF may be positioned in a distributed network architecture such that it can leverage infrastructure of a container orchestration platform deployed at the Edge (e.g., a distributed data center) and configured to perform a composition of resources deployed at the Edge. ‘Composition’ may refer to dynamic configuration of hardware and/or virtual infrastructure resources to meet a workload requirement.

According to some examples, an ICF may be deployed functionally between northbound resources (e.g., a resource orchestrator) and southbound resources (e.g., an infrastructure manager) in a network environment. The ICF may include a controller and a set of Custom Resource Definitions (CRDs). The controller may be used by the controller for composition of resources and the set of CRDs may enable storage and retrieval of structured data for composition operations. According to some examples, composable infrastructure, such as compute, storage, and/or networking resources, can be abstracted from their physical locations. Workloads and/or network services can be deployed on such composable infrastructure available at the Edge and within a shorter period by using an ICF that may be locally deployed.

According to some examples, based on a composition request (e.g., a resource specification) from northbound clients/users, one or more objects may be created using a set of CRDs. These objects may run during composition operation. Upon completion of composition operation, one or more objects may be deleted for efficient utilization of resources of the container orchestration platform. The controller may be configured to interact with southbound systems to query for resources and select a set of resources that are best suitable for the resource specification. Unlike some of the traditional resource composers that may be deployed at a central/core data center, an ICF may be lightweight making it feasible to be deployed at distributed data centers offering improved scalability. An ICF may be implemented at low cost and with a small infrastructure footprint as compared to some of the traditional resource composers, as dependency on dedicated infrastructure and customization of that infrastructure to suit environmental and operational conditions at the Edge may be reduced or eliminated.

According to some examples, an infrastructure composition-operator may include a controller component that runs on a pod of a container orchestration platform. Herein, the terms ‘infrastructure composition-operator’ and ‘controller’ may be interchangeably used. In some examples, an infrastructure composition-operator may use two Customer Resource Definitions (CRDs). A custom-object may be created based on a CRD and used for storage/retrieval of structured data in custom fields. According to some examples, the set of CRDs may include a first custom CRD that may be, e.g., a composer system-CRD and a second custom CRD that may be, e.g., an infrastructure manager-CRD.

A first custom-object (interchangeably referred to as “composer system-object”) based on a composer system-CRD can be used by user/northbound resources to search for resource requirements. For each infrastructure manager available, an infrastructure manager-object (interchangeably referred to as “second custom-object”) may be created based on a specification of the infrastructure manager-CRD. An infrastructure manager-object may check connectivity with a specific infrastructure manager and may maintain a connection status. Thus, an infrastructure manager-object may enable interaction with a specific infrastructure manager for the composition of resources. In some examples, a user creates a composer system-object by providing a set of resource requirements. The infrastructure composition-operator may identify the composer system-object and then, interact with southbound resources via an infrastructure manager-object for the composition of servers (network, storage, or compute). Upon completion of composition of resources, the composer system-object may be updated with resource details so that a northbound resource can access composed infrastructure details.

Present disclosures may enable seamless management of heterogeneous and multi-vendor infrastructure, as a user or a network administrator may not have to be familiarized with various composition service standards. According to some examples, a user may provide infrastructure requirements, such as an infrastructure manager-type, and/or a resource specification, in a data serialization format (e.g., YAML A'int Markup Language [YAML] format). The ICF of the present disclosure may be easy to use and intuitive from a users' point of view. Northbound applications, such as an orchestrator, may communicate infrastructure requirements via a data interchange file format. Based on input, the ICF may be configured to interact with infrastructure managers or resources aggregators for the composition of resources. Thus, ease of performing composition operations may be improved.

The following detailed description refers to the accompanying drawings. Wherever possible, the same reference numbers are used in the drawings and the following description to refer to the same or similar features. It is to be expressly understood that the drawings are for the purpose of illustration and description only. While several examples are described in this document, modifications, adaptations, and other implementations are possible. Accordingly, the following detailed description does not limit disclosed examples. Instead, the proper scope of the disclosed examples may be defined by the appended claims.

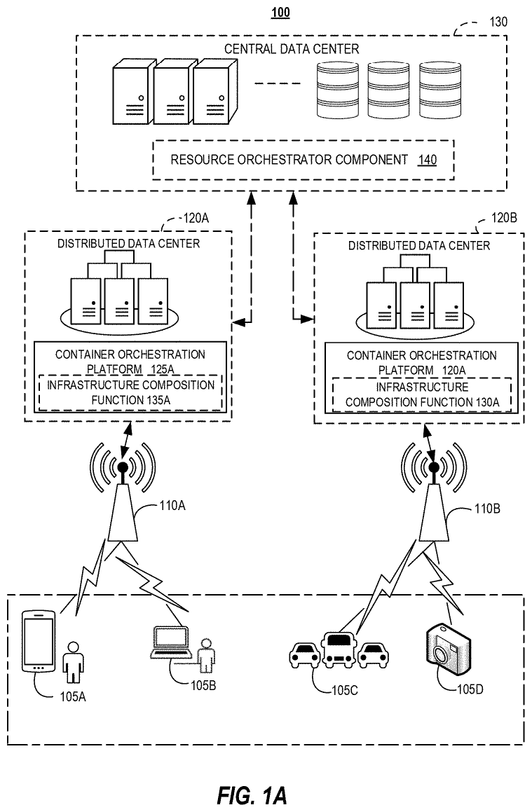

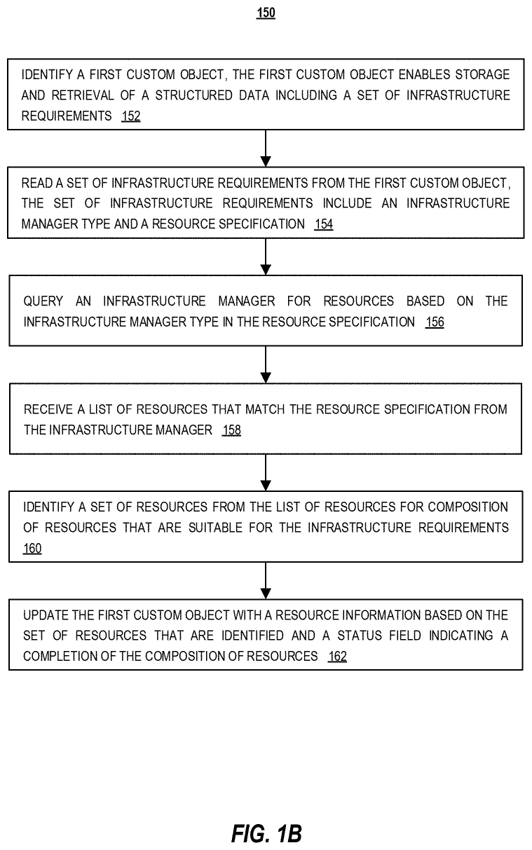

Before describing examples of the disclosed techniques in detail, it is useful to describe an example network environment with which these techniques might be implemented. FIG. 1A illustrates a schematic view of a physical topology of a network environment 100 that may be implemented for a telecom service provider. The network environment 100 may be constituted by one or more physical or geographical sites that may be deployed in a distributed manner. For example, the network environment 100 may include a central/core site, one or more regional sites, and one or more distributed sites that may be connected directly or via one or more regional sites to the central site.

Further, in the illustrative example of FIG. 1A, the network environment 100 can be used for providing low-latency and high-throughput network services (e.g., data services) to one or more user devices 105A-105D. A user device may be a communication device that connects to a network environment, which corresponds to a telecom network. In some examples, a telecom network may be based on a fifth-generation (5G) communication standard that can offer high-speed data connectivity. For example, a user device may establish a wireless link for transmitting and receiving voice/data via an uplink and downlink, respectively. A user device can be a mobile communication device 105A, a computing device 105B, a self-driving car 105C, a surveillance device 105D, an IoT enabled device, etc. Each of the user devices 105A-105D may connect to a cellular base station 110A, 100B, or an access point. Each cellular base station 110A, 110B (e.g., gNodeB, a 3^{rd} Generation Partnership Program (3GPP) 5G base station) may be configured to cover a geographical region to provide cellular service (e.g., voice and/or data) to user devices in that region.

In some examples, the network environment 100 may include one or more distributed data centers 120A, 120B that are deployed closer to the cellular base station 110. In other words, a distributed data center may comprise resources, such as storage, network, and compute, that are deployed closer to the Edge, as compared to a traditional data center that may be remotely deployed. The distributed data centers 120A, 120B may be configured with a Virtual Network Function (VNF) capability, in order to run applications associated with the network environment. Further, the distributed data centers 120A, 120B may be connected to a regional data center (not shown). Such regional data centers can be connected to a central data center. For brevity, the illustrative example of FIG. 1A depicts the distributed data centers 120A, 120B connected to a central data center 130. In some examples, the central data center 130 may include a resource orchestrator component 140 for managing various network services and/or Network Function Virtualization (NFV). For network services that may involve Virtual Network Functions (VNFs), the resource orchestrator component 140 may define topology and/or resource requirements for VNF/Cloud-Native Network Function (CNF). The resource orchestrator component 140 may request a resource composer for the resources. In a telecom service context, a resource orchestrator (e.g., the resource orchestrator component 140) may manage onboarding of new network services, handling VNF packages, lifecycle management of network services, resource management, etc. Network services in the form of workloads can be performed at one or more of the data centers that are available in the network environment 100.

In some examples, certain workloads that prefer low latency can be performed at distributed data centers 120A, 120B. The distributed data centers may include hardware resources, virtual resources, or any combination of hardware and virtual resources that may be disaggregated. Further, in some examples, a container orchestration platform 125A, 125B may be deployed at the Edge for running certain applications. In the ongoing example, the container orchestration platforms 125A, 125B may be deployed at the distributed data center 120A, 120B. A container orchestration platform can be utilized to automate the deployment, scaling, and monitoring of containerized applications. Moreover, container orchestration platforms can offer fault tolerance with high availability. According to some examples, for composition of resources, an Infrastructure Composition Function 135A, 135B can be deployed on a container orchestration platform 125A, 125B, which may be deployed at the Edge. The Infrastructure Composition Function 135A,135B can be a lightweight application that leverages the container orchestration platform 125A, 125B (e.g., Kubernetes architecture), which may be ubiquitous at the Edge, especially in a 5G network architecture. The composition may be performed based on resource requirements from a northbound client. For example, the resource requirements may specify an infrastructure manager (type) information and a resource specification.

An example method 150 of the composition of infrastructure resources is illustrated in FIG. 1B. The example method 150 is discussed in conjunction with the illustrative example of FIG. 1A for the composition of resources (e.g., resources hosted at the distributed data centers 120A, 120B) by an Infrastructure Composition Function 135A, 135B deployed on the container orchestration platform 125A, 125B, which may be at the distributed data center 120A or 120B. The Infrastructure Composition Function (ICF) 135A, 135B may include a controller, which may be an application-specific controller that can run on a pod of the container orchestration platform 125A, 125B and is capable of creating, configuring, and managing operations related composition of resources. In one example, the controller can be an infrastructure composition-operator defined herein, and the controller may use custom resources (e.g., custom-objects) for composition of resources. A custom-object can be created from a CRD, and the custom-object may include fields for storage/retrieval of data.

Now referring to method 150, at block 152, a controller may identify a first custom-object. In an example, the first custom-object may be based on a composer system-CRD. The first custom-object may be configured for storage and retrieval of structured data including a set of infrastructure requirements. A northbound resource, or a user, such as a client device, may specify a resource specification as per workloads requirements and accordingly, create the first custom-object. The controller may identify the first custom-object, when such object may be created.

At block 154, the controller may read a set of infrastructure requirements from the first custom-object. The set of infrastructure requirements may include an infrastructure manager-type and a resource specification. As the network architecture may include various infrastructure managers, a specific infrastructure manager-type may be specified by a northbound resource/user. An infrastructure manager, for example, a Virtual Infrastructure Manager (VIM), may control and manage Virtualized Network Functions (VNFs), compute, network, virtualized, and storage resources. Further, infrastructure managers may discover resource capabilities and features to optimize them. In some examples, these resources may be offered as a service using a cloud platform. The infrastructure managers may collect performance and fault information, and manage (add, delete, update, query, copy) virtual resources based on requests.

At block 156, the controller may query an infrastructure manager for resources based on the resource specification. For example, a user may specify a configuration of storage, compute, and/or network resources that may be used for running a network service. Further, the controller may query the infrastructure manager specified in the first custom-object. In some examples, addresses and/or credentials for accessing the infrastructure manager may be provided by a network administrator.

At block 158, the controller may receive a list of resources from the infrastructure manager. For example, a list of resources may include the composable resources that match the resource specification and that are free to be allocated. In some examples, the infrastructure manager may analyze the infrastructure resources that are being managed and may identify resources that satisfy one or more features specified in the resource specification.

At block 160, the controller may identify a set of resources that are suitable for the resource specification from the list of resources. In an example, the identification may be based on one or more selection conditions, such as an order of resources. In other words, resources that match the resource specification first in the list of resources may be selected. However, the identification of resources may include other non-limiting selection conditions discussed herein.

At block 162, the controller may update the first custom-object with resource information based on the set of resources that are selected. The resource information that may be updated may also include path information. Path information may correspond to an address/link (e.g., Uniform Resource Locator) to access the set of resources. In an example, the controller may change/update a status of a status field of the first custom-object and enable access to a set of resources through the path information. The first custom-object may be updated with an address (e.g., URL) of infrastructure resources that may be composed. The northbound client/user that has raised the request for resources may read the address from the first custom-object, which is composed. The composed resources can be accessed using the address specified in the first custom object. The process of composition of resources is further elaborated in the examples discussed herein.

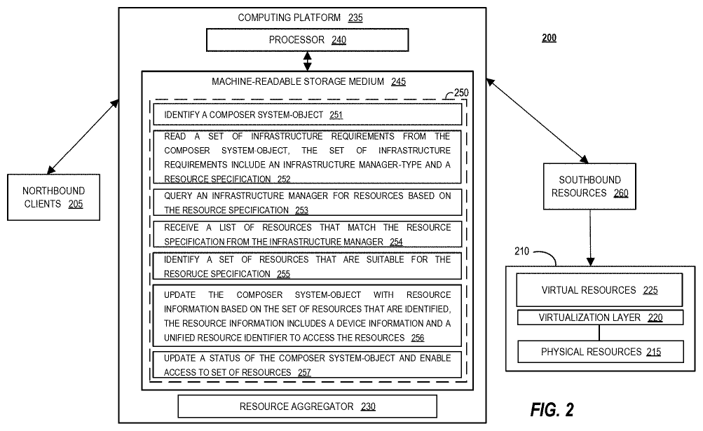

FIG. 2 illustrates an example of a schematic view of a computing platform in a network architecture, according to some examples of the present disclosure. The network architecture 200 may correspond to a Telecom Service Provider (TSP), an Internet Service Provider (ISP), an enterprise, a government agency, an institution, a sports arena, or the like. In some examples, the network architecture 200 may enable an enterprise to provide network services to a user. The network architecture 200 may include one or more northbound clients 205 to execute one or more network services on a collection of infrastructure resources 210. Herein, one or more northbound clients, such as an orchestrator or an Operational Support System (OSS), may monitor, control, analyze, and manage services on a network, e.g., request resources, retrieve an allocation status, etc. The collection of infrastructure resources 210 may be a plurality of physical resources 215 deployed at a distributed data center (e.g., the distributed data center 120A of FIG. 1A). In some further examples, a virtualization layer 220, such as a hypervisor layer, may be deployed for abstraction of the plurality of physical resources 215 into a plurality of virtual resources 225.

Further, the network architecture may include a resource aggregator 230 that may be provided to reflect a hierarchical nature of the distributed data centers. In the illustrative example, a resource aggregator 230 can be a distributed-data center-resource aggregator, which may be deployed to manage the infrastructure resources 210 associated with the distributed data center. The resource aggregator may be deployed on a computing platform 235. The computing platform 235 may be a set of servers (e.g., bare metal and/or virtual) that form an environment for deploying container orchestration platforms. It may be deployed near Edge, e.g., near the distributed data center, a base station of a TSP, or on-premise of a user-based on the use case. The infrastructure of the computing platform 235 may be utilized to run one or more workloads corresponding to at least one of a network function virtualization of a TSP or an enterprise customer. Such infrastructure may be leveraged for the composition of resources. In other words, the computing platform 235 may be configured to run an Infrastructure Composition Function for the composition of resources. In some examples, the infrastructure resources may be disaggregated hardware and/or virtual resources that may not be bound into a singular system. These disaggregated resources (e.g., network, compute, and/or storage) may be treated as individual resources. In various examples, these resources may be bound together in a logical system. Similar to traditional computing resources, these logical resources may be composed as per workload requirements.

The computing platform 235 may include a processor 240. The processor 240 may include a hardware processing resource, such as one or more Central Processing units (CPUs), semiconductor-based microprocessors, and/or other hardware devices suitable for retrieval and execution of the instructions 250. The processor 240 may fetch, decode, and execute instructions 250 stored in a machine-readable storage medium 245. As an alternative or in addition to retrieving and executing instructions, the processor 240 may include one or more electronic circuits that include electronic components for performing the functionality of one or more instructions, such as a field-programmable gate array (FPGA), application-specific integrated circuit (ASIC), or other electronic circuits.

In some examples, the machine-readable storage medium 245 may store instructions 250 (e.g., 251, 252, 253, 254, 255, 256, 257) executed by the processor 240 to perform the operations as described herein. The operations are not limited to a particular example described herein and may include additional operations such as those described in the illustrative examples of FIG. 1A, 1B, 3, 5A, 5B or 6.

The machine-readable storage medium 245 may be any electronic, magnetic, optical, or other physical storage device that contains or stores executable instructions. Thus, a machine-readable storage medium 245 may be, for example, Random Access Memory (RAM), non-volatile RAM (NVRAM), an Electrically Erasable Programmable Read-Only Memory (EEPROM), a storage device, an optical disc, and the like. In some examples, a machine-readable storage medium may be a non-transitory storage medium, where the term “non-transitory” does not encompass transitory propagating signals.

The computing platform 235, via the Infrastructure Composition Function, may be configured to communicate with various southbound resources 260. The southbound resources 260 may include, inter alia, various Virtual Infrastructure Managers (VIMs). For example, a VIM may control and manage various NFV Infrastructure (NFVI) compute, storage, and network resources. This may include orchestration of allocation, upgrade, release, and/or reclamation of NFVI resources with optimum use. Thus, the computing platform 235 may query southbound resources 260 for a list of resources that are suitable for a defined specification.

Referring now to the instructions 250, it may include instructions 251 that may be executable by the processor 240 that cause the processor 240 to identify a composer system-object. The composer system-object may be a CRD that would be managed by a controller (e.g., infrastructure composition-operator). The composer system-object may be created by a client/user from a northbound layer for the composition of resources to run a network service.

In some examples, instructions 252 may cause the processor 240 to read a set of infrastructure requirements from the composer system-object that is identified. The set of infrastructure requirements may, in some examples, include an infrastructure manager-type and a resource specification. A resource specification may include technical requirements, such as storage, network capability, processing speed, Quality of Service (QoS), Bandwidth, etc. Further, an infrastructure manager-type (e.g., infrastructure manager-1 or infrastructure manager-2) may also be specified under the set of infrastructure requirements.

In some examples, instructions 253 may cause the processor 240 to query the infrastructure manager for resources, based on the resource specification. For example, the infrastructure manager that may be specified in the composer system-object is queried for resources that match the resource specification.

In some examples, instructions 254 may cause the processor 240 to receive a list of resources that match the resource specification from the infrastructure manager. The infrastructure manager may identify various resources that are being managed by it and identify matching resources.

In some examples, instructions 255 may cause the processor 240 to identify a set of resources based on one or more selection conditions. For example, identification of a set of resources may be based on optimum usage of resources, latency requirements, availability, Service Level Agreements (SLAs), or the like. For example, if a resource specification includes a 12 GB of Random Access Memory (RAM) and the list of resources include a resource with 32 GB of RAM (listed first) and another resource with the 16 GB of RAM (listed second), the second resource may be selected for optimum utilization.

In some examples, instructions 256 may cause the processor 240 to update the composer system-object with resource information based on the set of resources that are identified. The resource information includes device information and a Unified Resource Identifier (URI) to access the set of resources. For example, device information may include manufacturer, model number, etc., and the URI can be a Distributed Management Task Force (DMTF) Redfish-URI for accessing that particular resource.

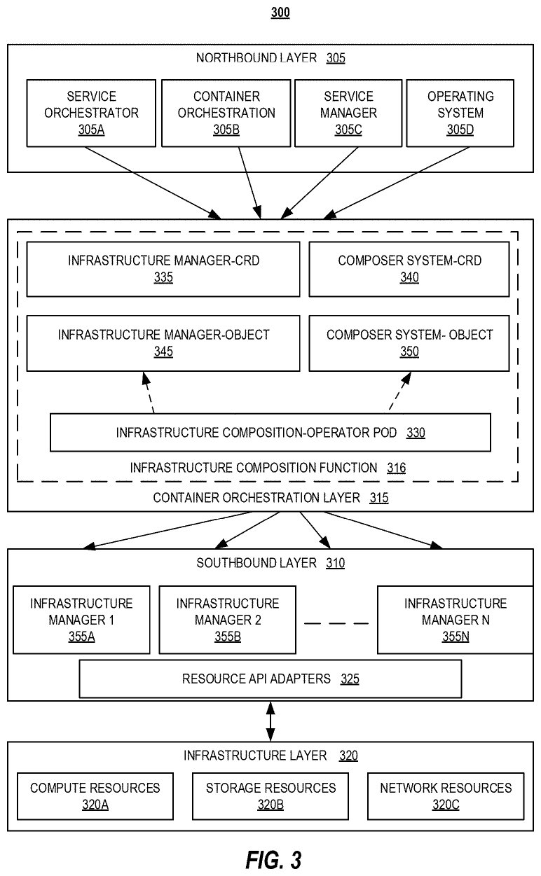

In some examples, instructions 257 may cause the processor 240 to update a status field of the composer system-object (e.g., status: completed) and enable access to a set of resources. The northbound client/resource that raised the composition request may identify the change/update in the status of the composer-object and may access the resources for running the workload/network service. Thus, the techniques for infrastructure composition can be performed by an Infrastructure Composition Function deployed on the computing platform 235, which is elaborated in FIG. 3.

FIG. 3 illustrates another schematic view of a network architecture and interactions among various components therein, according to some examples of the present disclosure. The network architecture 300 comprises a northbound layer 305, a southbound layer 310, and a container orchestration layer 315 disposed between the northbound and the southbound layers 305 and 310 respectively.

According to some examples, the northbound layer 305 may include northbound clients or users, such as service orchestrator 305A, a container orchestration platform 305B, a service manager 305C, or an operating system 305D. In some other examples, the northbound layer 305 may include Open source or third-party infrastructure provisioning tools, a command-line tool, etc. A command-line tool in the context of Kubernetes (example of container orchestration platform) may be kubectl, kubeadm, etc. Components of a northbound layer 305 may interact with a container orchestration platform via a dedicated API or through the command-line tool. In some examples, some of the northbound applications, for example, the service orchestrator 305A may communicate a set of infrastructure requirements via a data interchange file format using a Command-Line Interface (CLI), an Application Programming Interface (API), a Software Development Kit (SDK) supported by the container orchestration layer 315. For example, the data interchange file format may be a JavaScript object notation (JSON) format. In a further example of Kubernetes, it includes an API server, which exposes a Hypertext Transfer Protocol API that enables communication.

The southbound layer 310 may comprise one or more Resource Aggregators and/or one or more Virtualized Infrastructure Managers, VIMs (e.g., infrastructure manager-1 355A, infrastructure manager-2 355B, . . . infrastructure manager-N 355N). Herein, the VIMs may be referred to as infrastructure managers for brevity. Examples of infrastructure manager may include an Open Distributed Infrastructure Management (ODIM) standard, Metal as a Service (MAAS) standard, etc. In one example, an infrastructure manager may act as an abstraction and/or aggregation layer to manage multi-vendor, heterogeneous, and/or distributed infrastructure. It may enable both enterprises running applications and telecom service providers (such as 5G TSPs) to run services/workloads by utilizing an infrastructure layer 320. The infrastructure layer 320 may include compute 320A, storage 320B, and network resources 320C. The southbound layer 310 may interact with the infrastructure layer 320 via resource API adapters 325.

In some examples, one or more infrastructure managers may be deployed on the container orchestration platform (e.g., the container orchestration layer 315). For example, the ICF 316 may run on a duster of nodes of the container orchestration platform. In some further examples, the container orchestration layer 315 may also be utilized for running enterprise applications and/or telecom service provider-related applications. Thus, the physical footprint of ICF is minimal to zero as it leverages features of a container orchestration platform, such as Kubernetes.

Further, according to some examples, a container orchestration layer may comprise a cluster of resources (e.g., worker nodes) that are configured to run a workload (e.g., applications/network functions corresponding to 5G communication standard) on a pod. A pod may be the smallest deployable unit of computing on a container orchestration platform, and it may comprise a set of one or more running containers. In some examples, containers may be similar to VMs, but containers may share a host OS of a computing device among multiple application programs executing in the containers. Containers may provide a way to virtualize the host OS so that multiple workloads.

In the ongoing example, the ICF 316 includes an infrastructure composition-operator. The infrastructure composition-operator can be a custom operator that uses custom resources. An infrastructure composition-operator pod 330 can be deployed on a container orchestration platform that runs a controller part of the infrastructure composition-operator. As an example, the infrastructure composition-operator may be deployed on Kubernetes. The infrastructure composition-operator may be an application-specific controller that extends the functionality of Kubernetes API to create, configure, and/or manage instances of complex applications, such as composition of resources, on behalf of a Kubernetes user. Thus, the infrastructure composition-operator may build upon basic Kubernetes resource and controller concepts, and may include domain or application-specific knowledge to automate application/software that is being managed.

In further examples, an infrastructure composition-operator may be a custom controller, that uses custom resources, configured to manage composition of resource application and their components. In some examples, high-level configuration and settings, such as infrastructure manager Unified Resource Locators (URLs), access credentials, etc., may be provided by a user using a custom resource. The infrastructure composition-operator may translate high-level instructions into low-level actions. A custom resource may be an API extension mechanism in Kubernetes. The infrastructure composition-operator may watch for a custom resource and may take application-specific actions to make a current state match a desired state in the custom resource. Thus, the infrastructure composition-operator or its corresponding controller component may be configured to work in conjunction with resources to perform the composition of resources.

In some further examples, a container orchestration platform (e.g., Kubernetes) may include a resource model (not shown) which provides standard resource definitions (e.g., a service abstraction and an endpoint abstraction). Whereas a Custom Resource Definition extension mechanism can be used to extend the resource model to include custom resources and/or services. In one example, such a Custom Resource Definition may be used to define a set of CRDs. In one example, a set of Custom Resource Definitions (CRDs) may be defined for the application being deployed. For example, an infrastructure manager-CRD 335, and a composer system-CRD 340, which may be used by the infrastructure composition-operator may also be installed on the container orchestration platform. A CRD may enable the creation of custom resources for applications (e.g., infrastructure composition-operator function) being deployed on the container orchestration platform. In some examples, the CRDs may be stored on a distributed data store, such as an integrated etcd repository. These CRDs can leverage various built-in cluster management features which are associated with the container orchestration platform.

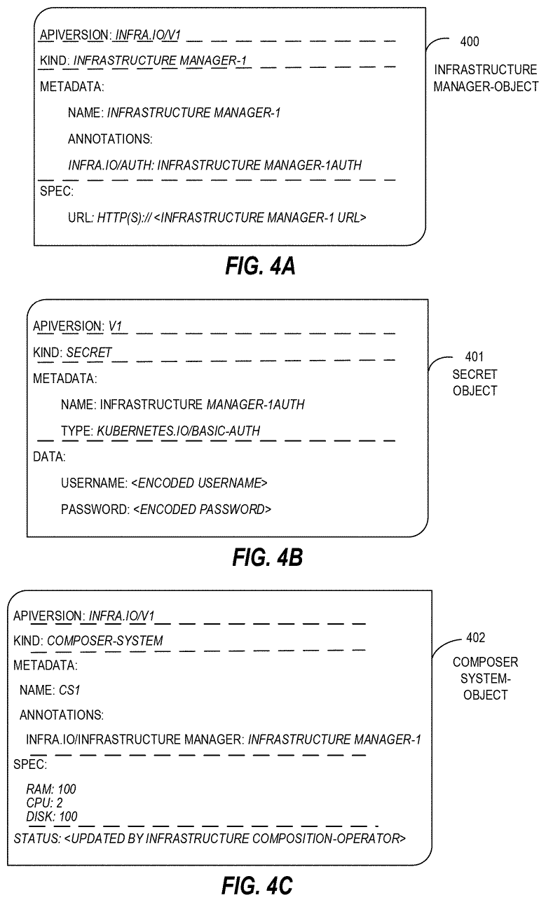

Further, the infrastructure composition-operator pod 330 is configured to manage the composition function application and its components. For example, a high-level configuration and settings may be provided by a user/administrator based on Custom Resource Definitions. The CRDs 335, 340 may be configured with specification(s) that enable northbound layer 305 to create a composer system-object 350 (example of a first custom-object) and infrastructure manager-object 345 (example of a second custom-object) for the composition of resources. The infrastructure manager-CRD 335 may enable the management of heterogeneous infrastructure and corresponding infrastructure managers. The composer system-CRD 340 may enable a user to search for infrastructure resources based on resource requirements. Further, based on a specification defined in an infrastructure manager-CRD 335, an infrastructure manager-object 345 may be created on a container orchestration platform. The infrastructure manager-object 345 may be provided with details for communicating with a specific virtual infrastructure manager. Similarly, a composer system-object 350 may be created based on a composer system-CRD and may include a resource specification specified by a user from northbound layer 305. The infrastructure manager-object and the composer system-object are further elaborated in FIGS. 4A-4C.

FIG. 4A illustrates a schematic view of an infrastructure manager-object 400, in accordance with various examples of the present disclosure. FIG. 4B illustrates a schematic view of a secret object 401, in accordance with various examples of the present disclosure. FIG. 4C illustrates a schematic view of a composer system-object 402, in accordance with various examples of the present disclosure. In the ongoing example illustrated FIGS. 4A-4B, the objects are considered as custom-objects created/added based CRDs supported by Kubernetes, for ease of discussion and not by way of limitation.

According to some examples, all objects may include two nested fields that may govern the object's configuration. One is a ‘“spec” field and the other is a “status”’ field. The spec field may refer to a specification and be used to indicate a desired state of the object and its characteristics. This spec field may be set by the user/northbound client/administrator during the creation of a respective object. Further, the object may include a ‘status’ field, which indicates a state of the object and may be updated by a corresponding controller/operator (e.g., the infrastructure composition-operator). The Orchestration layer may manage a current state of an object to match the desired state that may be provided.

The objects 401, 402, 403 may include certain common fields alongside certain custom fields for structured data. The structured data may be used for composition operation. Now referring to common fields, an ‘apiVersion’ field may be used to indicate a version of the Kubernetes object (e.g., v1, infra.io/vi, etc.). A ‘kind’ field may be used to indicate the name of the object type. A ‘metadata’ field may be used to indicate a dictionary of data related to the object, such as name, labels, credentials, annotations, etc. A user can provide the set of infrastructure requirements in the form of a YAML file (.yaml format). The Infrastructure Composition Function is configured to identify and communicate with the corresponding infrastructure manager. Users with no familiarity with infrastructure manager-specific interface standards may raise composition requests with ease.

Now referring back to FIG. 4A, the infrastructure manager-object 400 comprises access information, such as access Uniform Resources Locator (URL) (e.g., http(s)://<infrastructure manager-1's URL>) for accessing the corresponding infrastructure manager. This access information is provided in the spec field of the infrastructure manager-object 400 when creating it. In some examples, each infrastructure manager may have a dedicated infrastructure manager-object. Further, credentials may be provided for accessing the infrastructure manager and such credentials may be provided in the secret object 401.

The secret object 401 may have an apiVersion field as ‘v1’ and a “kind” field as ‘secret.’ The metadata includes a ‘name’ that helps in uniquely identifying the object. For example, the secret object 401 can be uniquely identified with ‘infrastructure manager-1auth.’ Whereas, a type field may indicate a type of validation to be performed. For example, “kubernetes.io/basic-auth” may indicate that the credentials are provided for basic authentication. A network administrator may specify the contents of a ‘data’ field. For example, a username and a password can be provided when creating the secret object 401. In further examples, the username and password may be encrypted for additional security.

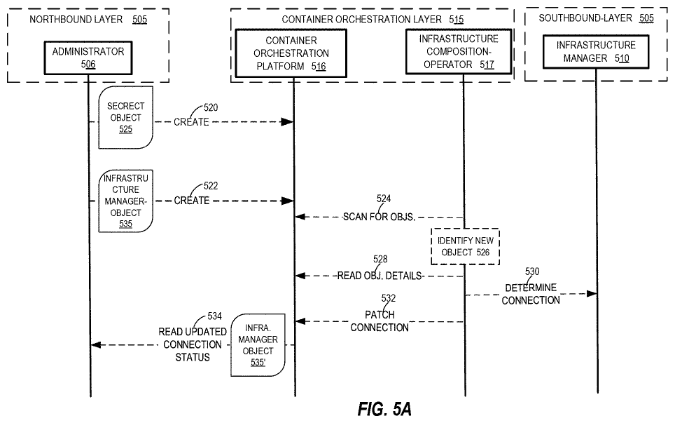

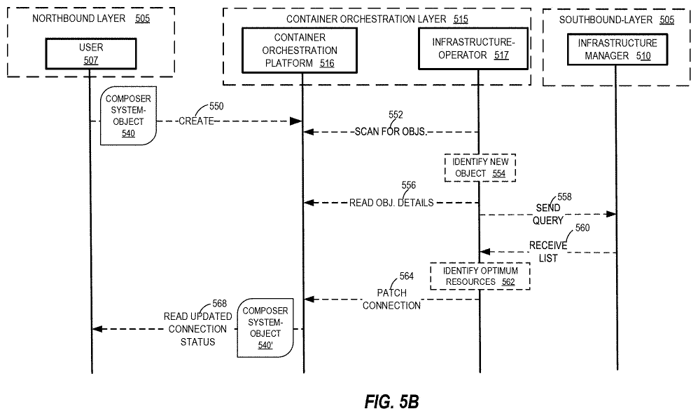

Now referring to the composer system-object 402. The composer system-object 402 also comprises a spec field, where a northbound client may have to specify the resource specification. For example, the composer system-object 402 illustrates three parameters (e.g., RAM: 100 [GB], CPU: 2 [cores], and DISK: 100 [GB]). In some other examples, the resource specification may include other parameters, such as QoS, bandwidth, availability, etc. Thus, when a northbound client/user wants to run a network service, then a resource requirement may be defined. A composer system-object may be created with a resource specification. For example, the custom resource definition may be a custom resource that extends the container orchestration platform's API and that is provided in the form of a configuration file using YAML format. Thus, an intuitive and simpler programming language (e.g., YAML) can be used for raising a request for the composition of resources and provision of specs in objects. In other words, YAML can be a data serialization/data-oriented language that is human-readable, which is used to input a resource specification to the ICF. The sequence of events for the composition of resources may be elaborated in illustrative examples of FIGS. 5A and 5B.

FIG. 5A illustrates a sequence diagram for creation of objects, which can be utilized for composition of resources, per various examples of the present disclosure. The network architecture includes a northbound layer 505, a container orchestration layer 510, and a southbound layer 515. The northbound layer 505 may include northbound clients, users, etc. The container orchestration layer 510 may include a container orchestration platform 516 and an infrastructure composition-operator 517 that is installed on the container orchestration platform 516. As discussed earlier, the infrastructure composition-operator 517 can be a custom operator that uses a set of CRDs, and its controller component may be running on a pod.

According to some examples of the present disclosure, a network administrator 506 may create 520 a secret object 525 (e.g., the secret object 401 of FIG. 4B). The secret object may contain sensitive data, such as credentials, a password, a token, or a key for securely accessing resources. The sensitive data can be encrypted so that no critical/confidential data may be put into an application code. In the ongoing example, a secret object 525 may include credentials for accessing an infrastructure manager. The credentials can be a username and a password. Further, the network administrator 506 may create 522 an infrastructure manager-object 535, based on an infrastructure manager-CRD. The infrastructure manager-object 535 may be provided with an infrastructure manager endpoint address, such as a URL, as part of the specification, to access a particular infrastructure manager. For example, the infrastructure manager endpoint address may include a host subcomponent (e.g., a hostname, registered name, or an IPv4/IPv6 address) and an optional port subcomponent preceded by a colon. An example format of infrastructure manager endpoint address can be “https://10.114.xx.xxx: 300xx.”

Further, the infrastructure composition-operator 517 may be registered for scanning any changes in objects. For example, the infrastructure composition-operator 517 may scan 524 and identify any infrastructure manager-object 535 that is created. Upon identifying 526 a new infrastructure manager-object 545, the infrastructure composition-operator 517 may read 528 object details from the infrastructure manager-object. In one example, the infrastructure manager-object may include information, such as endpoint address/URL and infra.io/auth annotation, which may indicate a name of a secret object to be referred to, for authentication of an infrastructure manager. Based on this information, the infrastructure composition-operator 517 may identify a corresponding secret object (e.g., the secret object 525) to connect to an infrastructure manager. For example, connecting may include establishing and confirming a connection 530 with a corresponding infrastructure manager. Based on the confirmation of a successful connection, the infrastructure composition-operator 517 patches the infrastructure manager-object with a connection status 532. The network administrator 506 at the northbound layer 505 can read the updated connection status 534 from the infrastructure manager-object 535′. Thus, the infrastructure composition-operator 517 of the ICF uses the infrastructure manager-object 535 and the secret object 525 to establish a connection with a specific infrastructure manager (e.g., the infrastructure manager). Similarly, an infrastructure manager-object and a corresponding secret object may be created for each infrastructure manager that is available and managing resources at the Edge or any of the data centers.

FIG. 5B illustrates a sequence diagram for a process for composition of resources, per various examples of the present disclosure. According to some examples, a user 507 at a northbound layer 505 may create 550 a composer system-object 540 by providing various infrastructure requirements in a spec field. For example, if a user needs an infrastructure with a RAM capacity of 100 GigaBytes, a Central Processing Unit (CPU) with two cores, and a storage space of 100 GB, then such requirements may be provided in the object specification (e.g., spec field), as illustrated in the example of FIG. 4C. Similar to the process defined in the example of FIG. 5A, an infrastructure composition-operator 517 may scan for objects 552 (e.g., the composer system-object 540). The infrastructure composition-operator 517 may identify the new object 554. The infrastructure composition-operator may read object details 556 from the composer system-object. The object details may include an infrastructure manager-type and a resource specification that may be specified by the northbound layer 505.

Further, the infrastructure composition-operator 517 may send query 558 to a corresponding infrastructure manager for the resource specification that is provided by a user. According to some examples, the infrastructure composition-operator 517 may interact with an infrastructure manager-object (e.g., the infrastructure manager-object 535 of FIG. 5A) to connect with the infrastructure manager. In one example, the infrastructure composition-operator 517 may identify an infrastructure manager-object corresponding to the infrastructure manager specified in the composer-system object 540. From the infrastructure manager-object, the infrastructure composition-operator 517 may obtain an infrastructure manager endpoint address and one or more credentials for accessing the infrastructure manager. In response to the query, the infrastructure composition-operator 517 may receive 560 a list of resources, which are available and match the resource specification provided in the composer system-object 540. The infrastructure composition-operator 517 identifies the best suitable resources/optimum resources 562 from the list of available resources. For example, the infrastructure composition-operator 517 may select a set of resources from the list based on one or more selection conditions. The one or more selection conditions may include latency, availability of that resources (e.g., uptime versus downtime), optimal match for the requirement, resource utilization, etc. For example, resource utilization may be a percentage of resource being utilized with a preference for higher utilization. For example, a resource requirement of 16 GB, a 32 GB resource may be of 50% utilization, whereas a 64 GB resource may be of 25% utilization. Then, for the set of resources that are selected, the infrastructure composition-operator 517 may patch a connection 564 (e.g., update details of a connection status to the infrastructure manager-object).

Further, the infrastructure composition-operator 517 updates the composer system-object with the details of the set of resources that can be allocated for running the workload/network service. In some examples, the composer system-object may be updated with a URI (e.g., a unified API URI, such as a DMTF standard Redfish URI), a system model, and other associated information with the set of resources. Further, a status field of the composer system-object 540′ (540′ may indicate that the object is updated) is updated (e.g., ‘completed’). The user can read 568 the updated composer system-object 540′ which is composed and find the details to access provisioned infrastructure. Thus, the infrastructure composition-operator and the CRDs that it uses may enable a user to compose resources just by providing a resource specification in YAML format, when a user, such as a telecom user, a network administrator, or like, wants to deploy a VNF with certain resource specification.

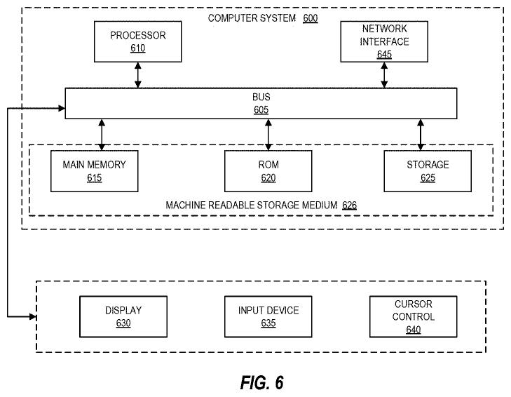

FIG. 6 depicts a block diagram of an example computer system 600 in which at least a portion of the disclosed infrastructure composition function may be implemented. The computer system 600 may enable the composition of resources (e.g., heterogeneous infrastructure resources). The computer system 600 may include a communication mechanism, such as a bus 605 for communicating information. One or more processors 610 may be coupled with bus 605 for processing information. Processor(s) 610 may be, for example, one or more general-purpose microprocessors. Further, the computer system 600 may include a main memory 615, such as a Random Access Memory (RAM), cache, and/or other dynamic storage devices, coupled to bus 605 for storing information and instructions to be executed by the processor 610. Main memory 615 also may be used for storing temporary variables or other intermediate information during the execution of instructions to be executed by processor 610.

The computer system 600 further may include a Read-Only Memory (ROM) 620 or other static storage device coupled to bus 605 for storing static information and instructions for processor 610. A storage device 625, such as a magnetic disk, optical disk, or USB thumb drive (Flash drive), etc., is provided and coupled to bus 605 for storing information and instructions. The computer system 600 may be coupled via bus 605 to a display 630 for displaying information to a computer user. An input device 635, including alphanumeric and other keys, is coupled to bus 605 for communicating information and command selections to processor 610. Another type of user input device is a cursor control 640 for command selections to processor 610.

In general, the word “component,” “system,” “database,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Per, or Python. It will be appreciated that software components may be callable from other components or from themselves, and/or may be invoked in response to detected events or interrupts. Software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

As used herein “heterogeneous infrastructure resources” may include multiple infrastructure resources found in a data center that are of different types and/or manufactured or distributed by different vendors. Non-limiting examples of types of infrastructure resources include compute infrastructure elements (e.g., processors, processor cores, computer systems, rack mount servers, and the like), storage infrastructure elements (e.g., storage systems and storage networking technologies, such as storage area networks (SAN), network-attached storage (NAS), redundant array of independent disks (RAID) and the like), network infrastructure (e.g., telecommunications systems, domain name system (DNS) servers, email servers, proxy servers, network security devices (e.g., firewalls, virtual private networking (VPN) gateways, intrusion detection systems and the like), gateway systems, routers, switches, and the like) and fabric infrastructure elements (e.g., switches).

The computer system 600 also may include a network interface 645 coupled to bus 605. Network interface 645 provides a two-way data communication coupling to one or more network links that are connected to one or more local networks. For example, the network interface 645 may be a local area network (LAN) card to provide a data communication connection to a compatible LAN (or WAN component to communicate with a WAN). Wireless links may also be implemented. In any of such examples, network interface 645 sends and receives electrical, electromagnetic, or optical signals that carry digital data streams representing various types of information. The signals through the various networks and the signals on the network link and through the network interface 645, which carry the digital data to and from computer system 600, are an example of forms of transmission media.

In some examples, a machine-readable storage medium 626 (e.g., one or more of the main memory 615, the ROM 620, or the storage device 625) may store instructions which when executed by the processor 610 may cause the processor 610 to execute techniques described in FIGS. 1A-5B. Some examples of instructions which when executed by the processor 610 may cause the processor 610 to compose resources based on a set of infrastructure requirements. The instructions may cause the processor 610 to identify a composer system-object. The instructions may cause the processor 610 to read a set of infrastructure requirements from the composer system-object. The set of infrastructure requirements includes an infrastructure manager and a resource specification. The instructions may cause the processor to query the infrastructure manager for resources based on the resource specification. The instructions may cause the processor 610 to receive a list of resources from the infrastructure manager. The instructions may also cause the processor 610 to identify a set of resources from the list of resources that are suitable for the set of infrastructure requirements. The instructions may cause the processor 610 to update the composer system-object with a resource information based on the set of resources that are identified. Further, a status field indicating a completion of the composition of resources may also be updated.

Various processes, methods, and algorithms described in the preceding sections may be embodied in, and fully or partially automated by, code components executed by one or more computer systems or computer processors comprising computer hardware. The one or more computer systems or computer processors may also operate to support the performance of the relevant operations in a “cloud computing” environment or as a “software as a service” (SaaS). The processes and algorithms may be implemented partially or wholly in application-specific circuitry. The various features and processes described above may be used independently of one another or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate or may be performed in parallel, or in some other manner. Blocks or states may be added to or removed from the disclosed examples. The performance of certain operations or processes may be distributed among computer systems or computers processors, not only residing within a single machine but deployed across a number of machines. Where a circuit is implemented in whole or in part using software, such software can be implemented to operate with a computing or processing system capable of carrying out the functionality described with respect thereto, such as computer system 600.

As used herein, the term “or” may be construed in either an inclusive or exclusive sense. Moreover, the description of resources, operations, or structures in the singular shall not be read to exclude the plural. Conditional language, such as, among others, “can,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open-ended as opposed to limiting. Adjectives such as “standard,” “known,” and terms of similar meaning should not be construed as limiting the item described to a given period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

I/We claim:

1. A method comprising:
identifying, by a controller deployed on a container orchestration platform, a first custom-object, wherein the first custom-object enables storage and retrieval of structured data including a set of infrastructure requirements;
reading, by the controller, the set of infrastructure requirements from the first custom-object, wherein the set of infrastructure requirements includes an infrastructure manager-type and a resource specification;
querying, by the controller, an infrastructure manager for resources based on the infrastructure manager-type in the resource specification;
receiving, by the controller, a list of resources from the infrastructure manager;
identifying, by the controller, a set of resources for composition of resources from the list of resources that are suitable for the set of infrastructure requirements; and
updating, by the controller, the first custom-object with resource information based on the identified set of resources and a status field indicating a completion of the composition of resources.

2. The method of claim 1, wherein:
the controller is a custom controller configured to work in conjunction with a set of custom-objects including the first custom-object, and
the first custom-object is a composer system-object created based on a composer system-Custom Resource Definition (CRD) that is deployed on the container orchestration platform.

3. The method of claim 1, further includes:
connecting, by the controller, with the infrastructure manager, wherein connecting includes establishing a connection with the infrastructure manager based on a Unified Resource Locator (URL) corresponding to the infrastructure manager.

4. The method of claim 1, wherein the querying includes:
identifying, by the controller, a second custom-object corresponding to the infrastructure manager-type specified in the first custom-object; and
obtaining, by the controller, an infrastructure manager endpoint address and one or more credentials from the second custom-object.

5. The method of claim 4, further comprising:
connecting, by the controller, to the infrastructure manager by reading the infrastructure manager endpoint address and the one or more credentials from the second custom-object; and
updating, by the controller, a status field of the second custom-object based on a successful connection to the infrastructure manager.

6. The method of claim 5, wherein the one or more credentials are provided in a secret object of the container orchestration platform to securely access the infrastructure manager.

7. The method of claim 5, wherein the second custom-object is created for each of the infrastructure manager and the second custom-object includes a spec field including information to access the infrastructure manager.

8. The method of claim 5, wherein the second custom-object is an infrastructure manager-object created based on an infrastructure manager-Custom Resource Definition (CRD) that is deployed on the container orchestration platform.

9. The method of claim 1 further comprises:
deleting, by the controller, the first custom-object upon completion of the composition of resources thereby freeing up resources of the container orchestration platform to run one or more pods associated with other applications.

10. The method of claim 1, wherein the resource information includes at least one of a Redfish-Uniform Resource Indicator (URI) to access the set of resources, and a device information corresponding to the set of resources.

11. A computing platform comprising:
a processor; and
a non-transitory storage medium storing instructions, the instructions executable by the processor, that cause the processor to:
identify a composer system-object updated with a set of infrastructure requirements;
read the set of infrastructure requirements from the composer system-object, wherein the set of infrastructure requirements include an infrastructure manager and a resource specification;
query the infrastructure manager for resources based on the resource specification;
receive a list of resources from the infrastructure manager;
identify a set of resources from the list of resources based on one or more selection conditions;
update the composer system-object with resource information based on the set of resources that are identified, wherein the resource information includes a device information and a Unified Resource Identifier (URI) to access the set of resources; and
update a status field in the composer system-object thereby enabling access to the set of resources for running one or more workloads thereon.

12. The computing platform of claim 11, wherein the instructions comprising further instructions that cause the processor to:
query an infrastructure manager-object for an infrastructure manager endpoint address and one or more credentials to access the infrastructure manager specified in the composer system-object.

13. The computing platform of claim 11, wherein the composer system-object is created based on specification defined by a composer system-Custom Resource Definition (CRD), and the composer system-object includes a spec field for providing the resource specification during creation of the composer system-object.

14. The computing platform of claim 11, wherein the composer system-object is provided with the set of infrastructure requirements in a data serialization format, and an infrastructure composition-operator installed on the computing platform interacts with the infrastructure manager through a composition service standard, thereby enabling a northbound client to provide input in the data serialization format that is independent of a composition service standard.

15. The computing platform of claim 11, wherein the computing platform is deployed at Edge of a network architecture, and infrastructure of the computing platform is utilized to run the one or more workloads corresponding to at least one of a network function virtualization of a telecom service provider or an enterprise customer and leveraged for composition of resources.

16. The computing platform of claim 14, wherein:
the computing platform is a container orchestration platform; and
the infrastructure composition-operator is a custom operator, and an infrastructure manager-object and the composer system-object are defined based on a set of Custom Resource Definitions (CRDs) deployed on the container orchestration platform.

17. An infrastructure composition function deployed on a container orchestration platform, comprising:
an infrastructure composition-operator, wherein the infrastructure composition-operator is a controller configured to manage a set of Custom Resource Definitions (CRDs), wherein the infrastructure composition-operator and the set of CRDs are installed by leveraging an infrastructure of a container orchestration platform deployed at Edge, wherein the Edge is a location proximal to a source of data when compared to a core data center, wherein
the set of CRDs include:
an infrastructure manager-CRD; and
a composer system-CRD, wherein
the infrastructure composition-operator performs a method comprising:
identifying a composer system-object, wherein the composer system-object is created based on the composer system-CRD and includes a spec field to specify an infrastructure manager-type and a resource specification;
reading the spec field from the composer system-object, and an infrastructure manager endpoint address and one or more credentials for accessing the infrastructure manager from an infrastructure manager-object, wherein the infrastructure manager is based on the infrastructure manager-CRD;
querying the infrastructure manager for resources based on the resource specification, wherein the infrastructure manager is configured to manage a set of heterogeneous resources deployed at a distributed-data center;
receiving a list of resources from the infrastructure manager, wherein the list of resources includes a plurality of resources that match the resource specification;
identify a set of resources from the list of resources based on one or more selection conditions;
updating the composer system-object with a resource information based on the set of resources that are identified, wherein the resource information includes a Unified Resource Identifier (URI) to and a device information of the set of resources; and
updating a status field in the composer system-object thereby enabling one or more workloads to be run on the set of resources.

18. The infrastructure composition function of claim 17, wherein the infrastructure composition function is part of a network architecture of a Fifth Generation (5G) communication system, and the infrastructure composition function is deployed functionally between a northbound layer and a southbound layer.

19. The infrastructure composition function of claim 18, wherein the northbound layer comprises at least one of a Resource Orchestrator, a Service Orchestrator, an Operating System, a User, another container orchestration platform, an Infrastructure as a Software (IaaS) tool, and a command-line tool for the container orchestration platform.

20. The infrastructure composition function of claim 18, wherein the southbound layer comprises one or more infrastructure managers, and each of the one or more infrastructure managers is responsible for integrated management of virtual resources that run on a set of heterogeneous resources.
